(19) United States
(12) Patent Application Publication
(10) Pub. No.: US 2020/0093302 A1
(43) Pub. Date: Mar. 26, 2020

(54) Hand Held Dosing unit for Granular or Powders

(71) Applicant: David S. Smith America, Inc., DBA, Worldwide Dispensers, Lester Prairie, MN (US)

(72) Inventors: Ronald E. Kieras, Woodstock, IL (US); Matthew Ruschmeier, Glencoe, MN (US)

(73) Assignee: David S. Smith America, Inc., DBA, Worldwide Dispensers, Lester Prairie, MN (US)

(21) Appl. No.: 16/551,983

(22) Filed: Aug. 27, 2019

Related U.S. Application Data
(60) Provisional application No. 62/723,213, filed on Aug. 27, 2018.

(51) Int. Cl. A47G 19/34; G01F 11/26; B65D 83/06

(52) U.S. Cl. CPC A47G 19/34; B65D 83/06; G01F 11/261

(57) ABSTRACT

A dispenser having a container for holding solid material to be dispensed. A metering dispenser is connected to the open bottom end of the container, the metering dispenser further including a button connected to a slide, the slide having a metering chamber which slides horizontally in a slide chamber. The slide chamber has an upper opening in communication with the open bottom end of the container and the slide chamber has a lower dispensing opening. The solid material fills metering chamber which is sized to hold a predetermined amount of the solid material, the solid material filling the metering chamber by gravity feed when the button is in the closed position, in which the metering chamber is in communication with the upper opening in the slide chamber. The solid material is dispensed when the button is depressed to slide the metering chamber over the lower dispensing opening.

### CROSS-REFERENCE TO RELATED APPLICATIONS

This Application claims the benefit of and priority to U.S. Provisional Application No. 62/723,213, filed Aug. 27, 2018, the entire contents of which are herein incorporated by reference.

### STATEMENT REGARDING FEDERALLY SPONSORED RESEARCH

Not Applicable.

### BACKGROUND OF THE INVENTION

There is a need for a hand held compact dispenser for granular products, powders or spices, which has pre-measured dosing, which is easy to manufacture and is inexpensive.

Without limiting the scope of the invention a brief summary of some of the claimed embodiments of the invention is set forth below. Additional details of the summarized embodiments of the invention and/or additional embodiments of the invention may be found in the Detailed Description of the Invention, below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

In some embodiments, the invention is a dispenser for solids having a container for holding the solid material to be dispensed, the container having an open bottom end. A metering dispenser is connected to the open bottom end of the container, the metering dispenser further including a button connected to a slide, the slide having a metering chamber which slides horizontally in a slide chamber. The slide chamber has an upper opening in communication with the open bottom end of the container and the slide chamber has a lower dispensing opening. The solid material fills metering chamber which is sized to hold a predetermined amount of the solid material, the solid material filling the metering chamber by gravity feed when the button is in the closed position, in which the metering chamber is in communication with the upper opening in the slide chamber. The solid material is dispensed when the button is depressed to slide the metering chamber over the lower dispensing opening. The button is elastic so that when not depressed, the button and slide return to the closed undepressed position, in which the metering chamber is brought back into alignment with the upper opening in the slide chamber. This allows the next dose to be prepared.

The dispenser can be made any size. For example, one version has a metering chamber sized to delivery approximately 0.0344 cubic inches of solid material (a 20 mm powder dispenser). A second version has a metering chamber sized to delivery approximately 0.1505 cubic inches of solid material (a 28 mm powder dispenser). A third version has a metering chamber sized to delivery approximately 0.3581 cubic inches of solid material (a 38 mm powder dispenser).

The metering dispenser is threadably connected to the container. The slide has a stem which is connected to the button.

### BRIEF DESCRIPTION OF THE DRAWINGS

FIG. 1 shows the front, right and top views of the invention.

FIG. 2 shows the left and front views of the invention.

FIGS. 3A, 3B and 3C shows the invention in the closed, half open position and fully open position.

FIGS. 4A, 4B and 4C shows a bottom view of the invention in the closed, half open position and fully open position.

FIGS. 5A, 5B and 5C shows a cross-section view of the invention in the closed, half open position and fully open position.

FIGS. 6A, 6B and 6C shows the metering chamber in a cross-sectional view in the closed, half open position and fully open position.

FIGS. 7A, 7B, 7C, 7D and 7E shows a 20 mm powder dispenser version of the invention in various cross-sectional positions between closed, half-open, fully open, half-closed and fully closed.

FIGS. 8A, 8B and 8C shows the 20 mm powder dispenser portion in the closed, half and open positions.

FIGS. 9A, 9B and 9C shows the entire 20 mm dispenser in the closed, half and open positions.

FIGS. 10A, 10B, 10C, 10D and 10E shows a 28 mm powder dispenser version of the invention in various cross-sectional positions between closed, half-open, fully open, half-closed and fully closed.

FIGS. 11A, 11B and 11C shows the 28 mm powder dispenser portion in the closed, half and open positions.

FIGS. 12A, 12B and 12C shows the entire 28 mm dispenser in the closed, half and open positions.

FIGS. 13A, 13B, 13C, 13D and 13E shows a 38 mm powder dispenser version of the invention in various cross-sectional positions between closed, half-open, fully open, half-closed and fully closed.

FIGS. 14A, 14B and 14C shows the 38 mm powder dispenser portion in the closed, half and open positions.

FIGS. 15A, 15B and 15C shows the entire 38 mm dispenser in the closed, half and open positions.

### DETAILED DESCRIPTION OF THE INVENTION

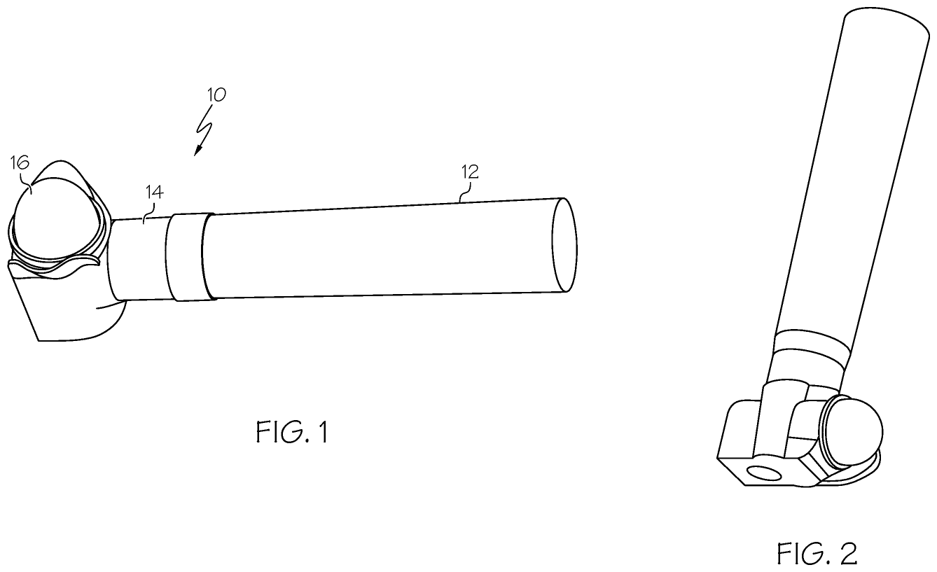

Referring to FIGS. 1 and 2, the inventive dispenser is shown generally at 10. A container for holding the powder material is shown at 12. The container has a closed top end and an open bottom end. A metering dispenser 14 is connected to the open bottom of the container 12. An elastic button is shown at 16.

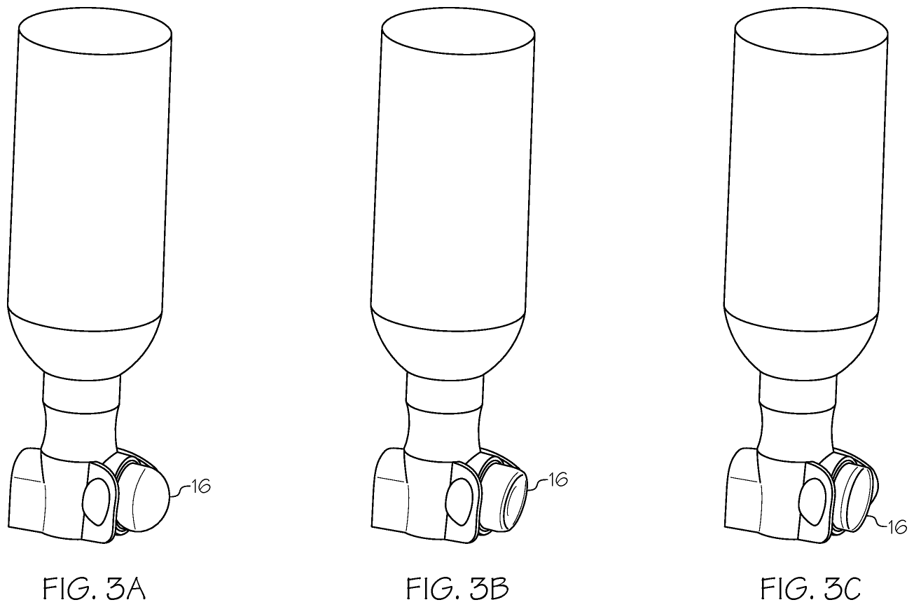

Referring to FIG. 3A-3C, the dispenser is shown with the button 16 in the closed position (undepressed), a half-open position (partially depressed) and a fully open position (fully depressed). The elastic button is normally closed, so once it is no longer being depressed, it elastically returns to the closed position.

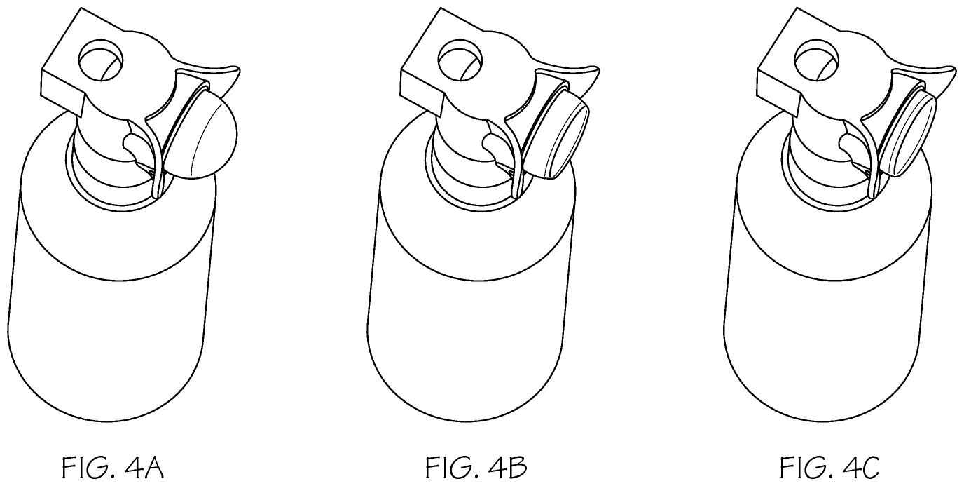

FIGS. 4A-4C show the same stages as FIG. 3, but from the bottom of the dispenser.

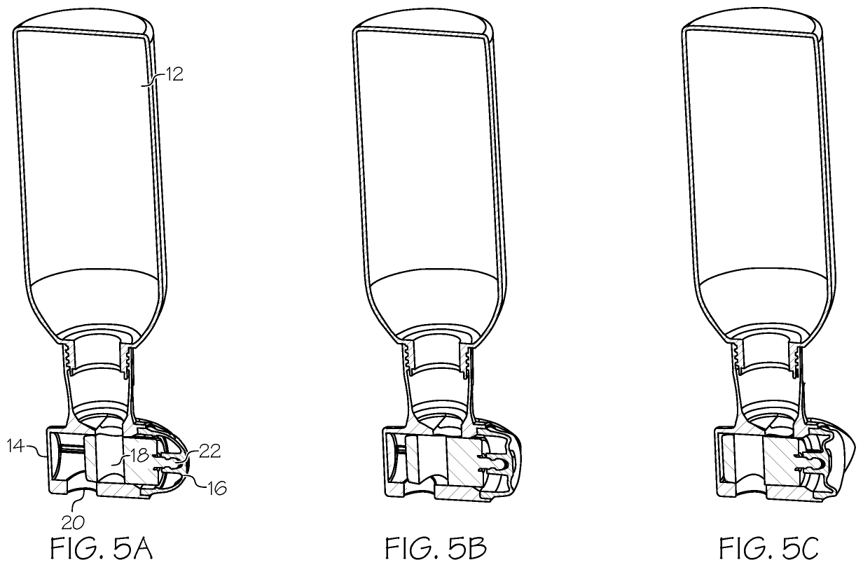

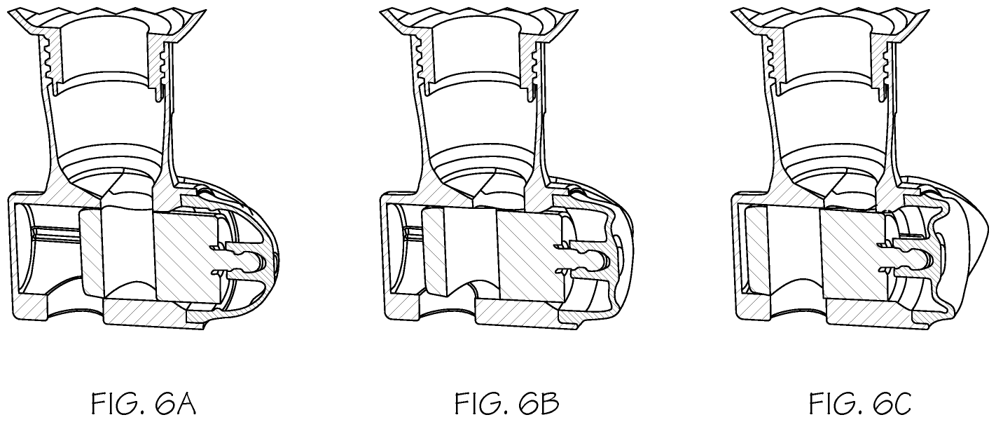

Referring to FIGS. 5A-5C and 6A-6C, a cross-section view of the dispenser is shown in the closed, half and open positions. This view shows the metering chamber 18 as it aligns with the open bottom end of the container 12 in the closed position, allowing it to be filled with the powder in the container, by gravity. In the open position, when the button is depressed, the metering chamber is slid over the open bottom end 20 of the metering dispenser. The metering chamber also includes a stem 22, which is used to attach the elastic button to the dispenser.

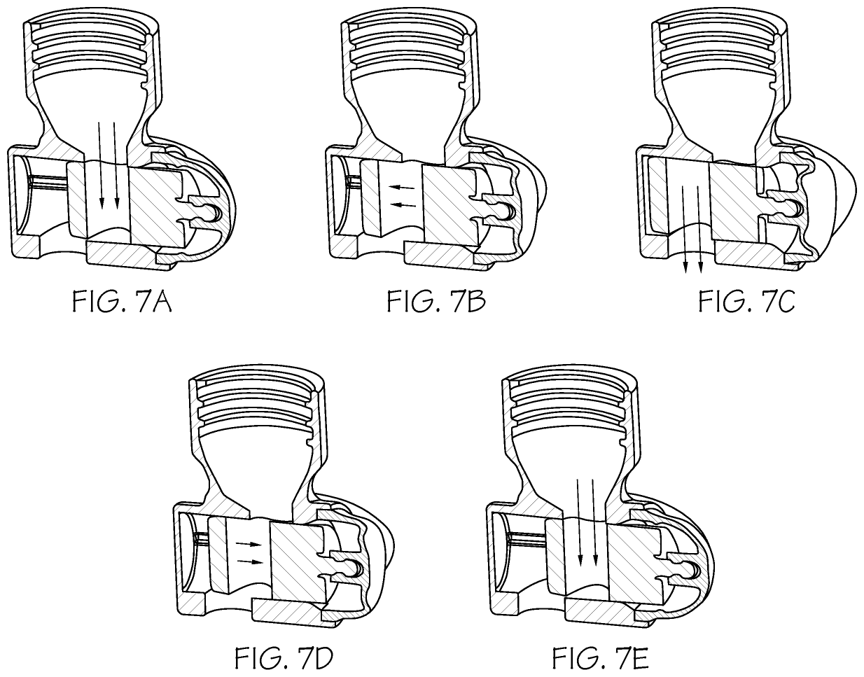

FIGS. 7A-7E show the 20 mm version of the invention in five different positions, from closed, half-open, fully open, half-closed and fully closed. Threads 24 can be used to attach the metering dispenser 14 to the container 12, or the metering dispenser could be snap fit to the container 12.

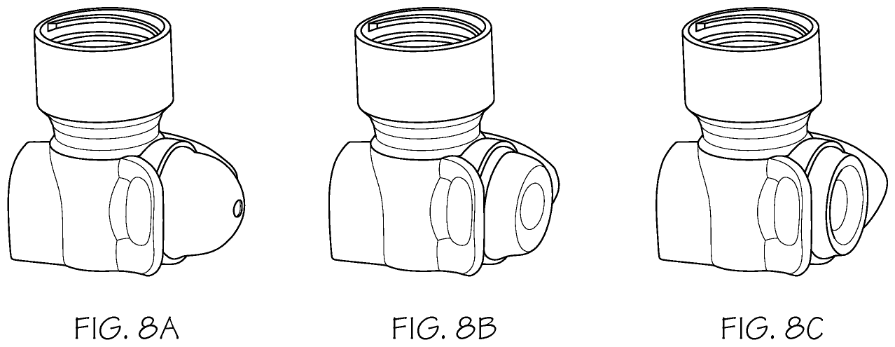

FIGS. 8A-8C show an outside view of the 20 mm version of the metering dispenser 14 in the closed, half and open positions.

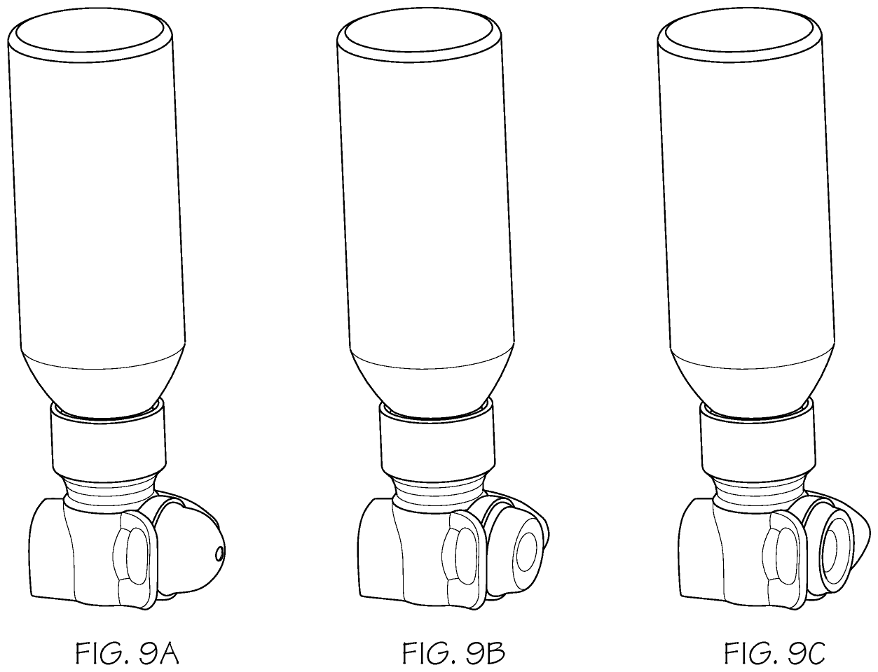

FIGS. 9A-9C show an outside view of the entire 20 mm dispenser in the closed, half and open positions.

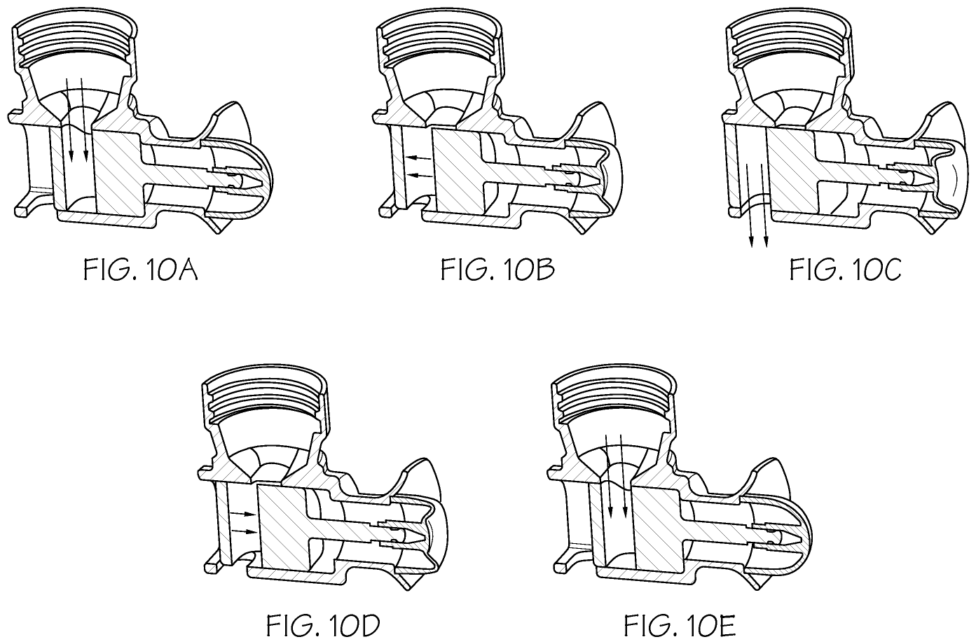

FIG. 10A-10E shows a 28 mm powder dispenser version of the invention in five different positions, from closed, half-open, fully open, half-closed and fully closed.

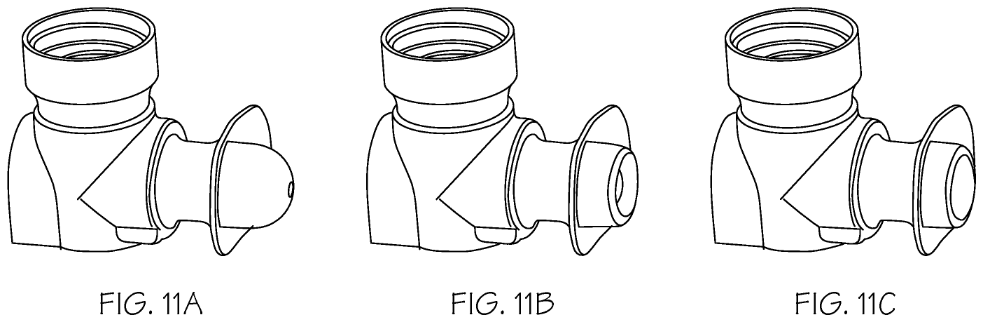

FIG. 11A-11C shows the 28 mm powder dispenser portion 14 in the closed, half and open positions.

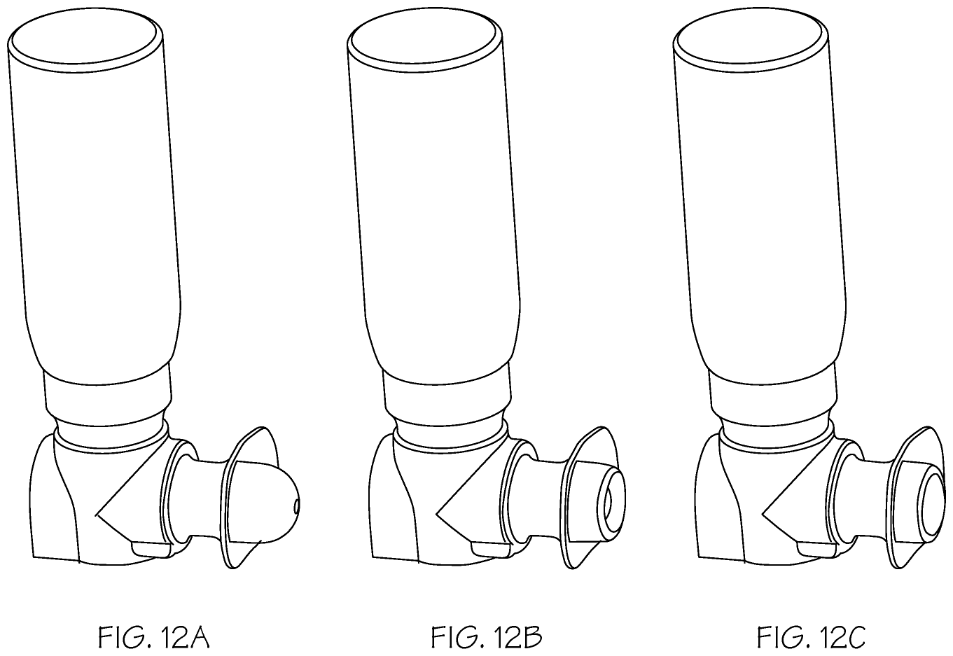

FIG. 12A-12C shows the entire 28 mm dispenser in the closed, half and open positions.

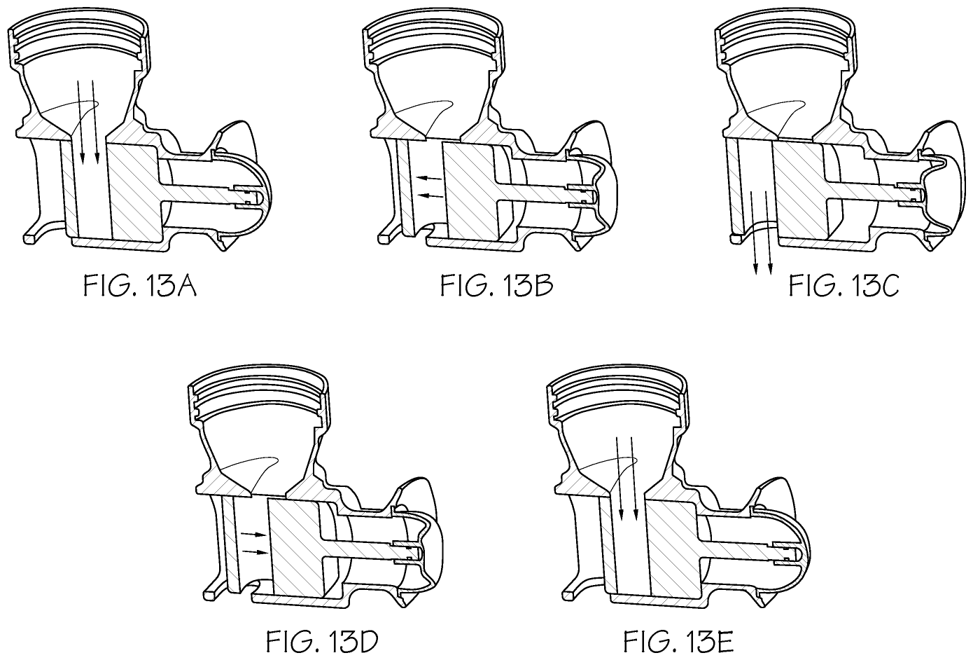

FIG. 13A-13E shows a 38 mm powder dispenser version of the invention in five different positions, from closed, half-open, fully open, half-closed and fully closed.

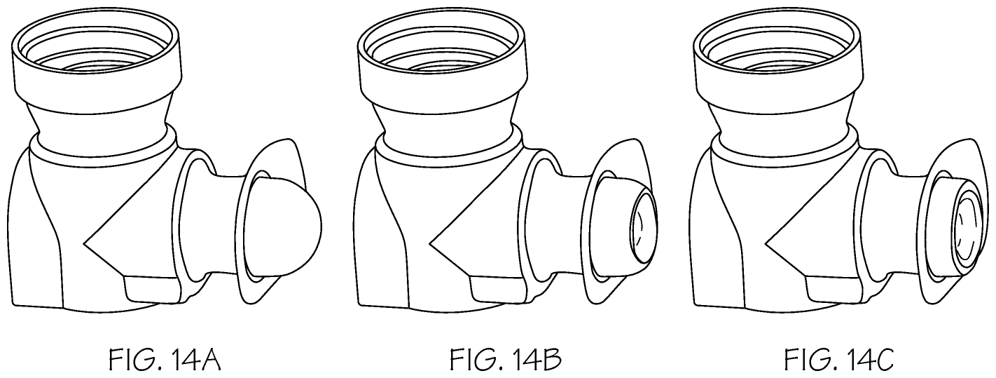

FIG. 14A-14C shows the 38 mm powder dispenser portion 14 in the closed, half and open positions.

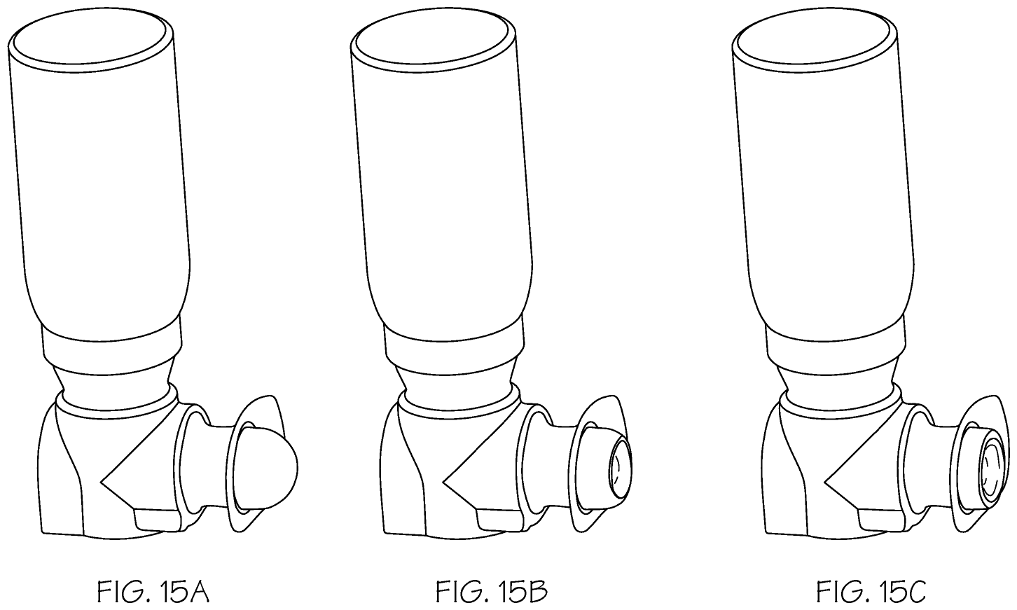

FIG. 15A-15C shows the entire 38 mm dispenser in the closed, half and open positions.

The above disclosure is intended to be illustrative and not exhaustive. This description will suggest many variations and alternatives to one of ordinary skill in this field of art. All these alternatives and variations are intended to be included within the scope of the claims where the term “comprising” means “including, but not limited to.” Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A dispenser for solids comprising:
a container for holding the solid material to be dispensed, having an open bottom end;
a metering dispenser connected to the open bottom end, the metering dispenser further comprising a button connected to a slide, the slide having a metering chamber which slides horizontally in a slide chamber;
the slide chamber having an upper opening in communication with the open bottom end of the container and the slide chamber having a lower dispensing opening;
the solid material filling a metering chamber which is sized to hold a predetermined amount of the solid material, the solid material filling the metering chamber by gravity feed when the button is in the closed position, in which the metering chamber is in communication with the upper opening in the slide chamber;
the solid material being dispensed when the button is depressed to slide the metering chamber over the lower dispensing opening,
the button being elastic so that when not depressed, the button and slide return to the closed undepressed position, in which the metering chamber is brought back into alignment with the upper opening in the slide chamber.

2. The dispenser of claim 1 wherein the metering chamber is sized to delivery approximately 0.0344 cubic inches of solid material.

3. The dispenser of claim 1 wherein the metering chamber is sized to delivery approximately 0.1505 cubic inches of solid material.

4. The dispenser of claim 1 wherein the metering chamber is sized to delivery approximately 0.3581 cubic inches of solid material.

5. The dispenser of claim 1 wherein the metering dispenser is threadably connected to the container.

6. The dispenser of claim 1 wherein the slide has a stem which is connected to the button.
